(19) United States
(12) Patent Application Publication
(10) Pub. No.: US 2017/0076903 A1
(43) Pub. Date: Mar. 16, 2017

(54) X-RAY TUBE

(71) Applicant: Michael Turner, Richmond, IN (US)

(72) Inventor: Michael Turner, Richmond, IN (US)

(21) Appl. No.: 15/265,804

(22) Filed: Sep. 14, 2016

Related U.S. Application Data
(60) Provisional application No. 62/218,266, filed on Sep. 14, 2015.

(51) Int. Cl. H01J 35/06; H01J 35/14; H01J 35/16; H01J 35/08

(52) U.S. Cl. CPC H01J 35/06; H01J 35/08; H01J 35/14; H01J 35/16; H01J 2235/081; H01J 2235/06

(57) ABSTRACT

Systems, methods, and apparatuses for providing a directional output of X-rays are provided. In one embodiment, a sealed X-ray tube for use in portable X-ray devices is provided, and may comprise: a tube body; an anode comprising a notched focal spot portion, and a cathode cap comprising a cathode; wherein the cathode may be operable to direct a flow of electrons toward the notched focal spot portion of the anode such that electrons colliding with the notched focal spot portion may generate X-rays that may be output from the X-ray tube in a direction substantially orthogonal to a longitudinal axis of the anode and the X-ray tube.

### CROSS-REFERENCE TO RELATED APPLICATIONS

This application claims priority from U.S. Provisional Patent Application No. 62/218,266 filed on Sep. 14, 2015, which is incorporated by reference herein in its entirety.

### BACKGROUND

X-ray technology may be used for detection of explosives, non-destructive testing, and other industrial radiography. Some X-ray applications may require a relatively small X-ray source device that may be easily portable. Design and configuration of some structures may limit imaging from a portable X-ray source.

X-ray tubes in portable X-ray sources may output X-rays used for radiography in a forward-directed geometry along a longitudinal axis of the X-ray tube. For example, traditional cold cathode, pulse-style X-ray tubes may emit X-rays in a “forward” direction along a longitudinal axis of the anode, and more generally along the longitudinal axis of the X-ray tube itself. Radiography of structures with X-ray tubes and portable X-ray sources emitting forward-directed X-ray output, may be limited to structures where an X-ray tube and portable X-ray source may be positioned to output X-rays in a forward-directed line-of-sight toward a target structure. Some target structures may include designs and configurations that may prevent a line-of-sight positioning of X-ray tubes and portable X-ray sources utilizing forward-directed X-ray output.

The present application is directed to a novel X-ray tube, systems, and methods to directionally output X-rays used for radiography.

### SUMMARY

Systems and methods for generating and directionally outputting X-rays from an X-ray tube are provided.

In one embodiment, a sealed X-ray tube for use in small X-ray source devices is provided, the sealed X-ray tube comprising: a tube body comprising a distal end and a proximal end and at least one side extending in an axial direction to interconnect the distal end and the proximal end; an anode positioned on a central axis of the tube body and within the tube body, the anode comprising a notched focal spot portion, wherein the notched focal spot portion is operable to direct an emission of X-rays out of the tube body in a direction substantially orthogonal to a longitudinal axis of the anode; and a cathode cap, the cathode cap operable to seal the distal end of the tube body, wherein the cathode cap further comprises a cathode, the cathode operable to direct a flow of electrons toward the anode.

In another embodiment, a portable X-ray source to generate X-rays for radiography is provided, the portable X-ray source comprising: an elongated canister portion comprising a sealed X-ray tube comprising a notched anode operable to emit X-rays in a direction substantially orthogonal to an axis of the notched anode, the sealed X-ray tube positioned within an internal volume of the elongated canister portion; and at least one of: a control module operatively connected to at least one of: a power source, and a high-voltage pulse generator; and a canister collimator window through which X-rays emitted from the sealed X-ray tube may be directed toward a target source to be radiographed.

In another embodiment, a method for producing and outputting X-rays for radiography is provided, the method comprising: generating a high voltage pulse to create a potential difference between an anode and a cathode to accelerate electrons emitted from a cathode in a sealed X-ray tube radially toward a notched focal spot portion of an anode, wherein the notched focal spot portion of the anode comprises at least one of: a first face, and a second face; and colliding accelerated electrons from the cathode with the at least one of: the first face, and the second face, to generate and output X-rays in a direction substantially orthogonal to a longitudinal axis of the anode.

### BRIEF DESCRIPTION OF THE DRAWINGS

The accompanying figures, which are incorporated in and constitute a part of the specification, illustrate various example systems and methods, and are used merely to illustrate various example embodiments.

FIG. 1 illustrates an example X-ray tube.

FIG. 2 illustrates a perspective view of a notched portion on an anode of an example X-ray tube.

FIG. 3 illustrates a cross-sectional view of an example X-ray tube.

FIG. 4 illustrates an example portable X-ray device.

FIG. 5 is a flow chart of an example method for generating and outputting X-rays in an example X-ray tube.

### DETAILED DESCRIPTION

Embodiments claimed herein disclose example X-ray tubes, portable X-ray devices, and methods, used to generate and directionally output X-rays toward a target device for radiography.

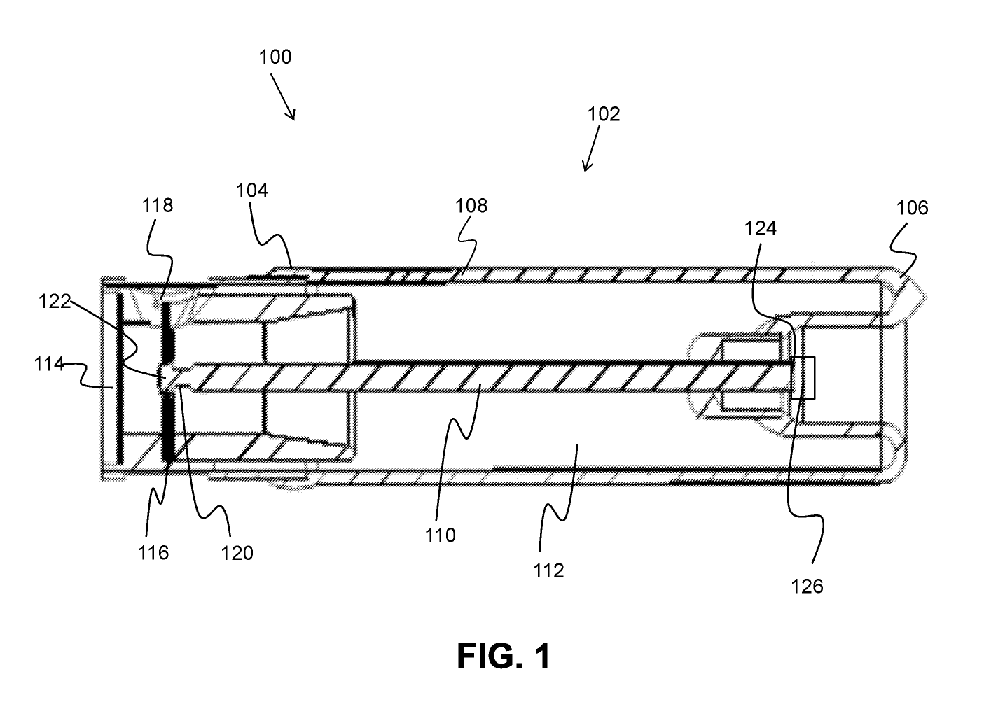

With reference to FIG. 1, an example sealed X-ray tube 100 for use in portable X-ray devices is illustrated. In one embodiment, sealed X-ray tube 100 may be a sealed cold cathode pulsed X-ray tube 100. Sealed X-ray tube 100 may comprise a tube body 102 comprising a distal end 104, a proximal end 106, and at least one 108 side extending axially in a longitudinal direction to interconnect the distal end and the proximal end. Sealed X-ray tube 100 may further comprise an anode 110 disposed centrally within an inner volume 112 of tube body 102 and extending along a longitudinal axis of tube body 102 from proximal end 106 toward distal end 104. Sealed X-ray tube 100 may further comprise cathode cap 114 toward a distal end 104 of tube body 102. Cathode cap 114 may comprise one or more cathodes 116 and a collimator window 118.

In one embodiment, side 108 of tube body 102 is tubular in shape. Side 108 may be of an electrically insulator material to provide insulation between anode 110 and one or more cathodes 116. In one embodiment, side 108 of tube 102 is a glass material. In another embodiment, side 108 of tube 102 is a ceramic material. Cathode cap 114 may provide an airtight seal at distal end 104 of tube body 102 such that inner volume 112 of tube body 102 may be under vacuum—that is, inner volume 112 may comprise an absence of air. A vacuum in inner volume 112 of tube body 102 may provide an optimal environment for electron flow from cathode 116 toward a focal spot on anode 110. Portions (not shown) of distal end 104 of tube body 102 may comprise a stainless steel (or like weldable metal) that may be welded to portions of cathode cap 114 to seal cathode cap 114 to tube body 102 so as to provide a sealed environment to maintain a vacuum within inner volume 112.

Anode 110 may be disposed centrally within inner volume 112 of tube body 102. Anode 110 may comprise a notched focal spot portion 120 disposed toward a distal end 122 of anode 110. In one embodiment, electrons produced by cathode 116 are directed toward notched focal spot portion 120 on anode 110. A geometry of notched focal spot portion 120 may be operable to directionally output X-rays emitted from anode 110, for example, in a direction substantially orthogonal to a longitudinal axis of X-ray tube 100. Anode 110 may be of an electrically conductive metal operable to withstand high temperatures, for example, such as, but not limited to: tungsten, molybdenum, an alloy comprising high percentages of such metals, for example, tungsten, molybdenum, and the like, stainless steel, and like materials.

X-rays emitted from anode 110 may be output in a direction substantially orthogonal to a longitudinal axis of anode 110 and X-ray tube 102. In one embodiment, X-rays emitted from anode 110 are output through collimator window 118 on cathode cap 114 and external to tube body 102. Cathode cap 114 may comprise a stainless steel or like material that may be machined, for example, to hold cathodes 116. For example, cathodes 116 may be an incomplete annular shape, and cathode cap 114 may be a stainless steel material that may be machined with a notch of a thickness corresponding to cathodes 116 to hold cathodes 116 in position relative to cathode cap 114, anode 110, and sealed X-ray tube 100. Portions of stainless steel cathode cap 114 may be welded to corresponding stainless steel (or like weldable metal portions) on tube body 102 to seal tube body 102 with cathode cap 114 to maintain a vacuum within inner volume 112 tube body 102.

Cathode cap 114 may comprise one more cathodes 116. In one embodiment, cathode 116 is a cathode ring 116 substantially annular in shape. In another embodiment, cathode 116 is an incomplete annular shape. In another embodiment, cathode 116 is a shape comprising diametrically opposed incomplete semicircles. Cathode 116 may emit electrons radially toward anode 110. In one embodiment, cathode 116 includes a cold cathode 116 such that cold cathode 116 does not emit electronics through a thermionic effect, but rather emits electrons toward notched focal spot portion 120 of anode 110 when a high voltage potential is created between anode 110 and cathode 116. In one embodiment cathode 116 emits electrons radially toward notched focal spot portion 120 of anode 110. In one embodiment, cathode 116 is of a woven graphite fabric material. In another embodiment, cathode 116 is comprised of a carbon cloth material. In another embodiment, cathode 116 is comprised of a tungsten foil material. In another embodiment, cathode 116 may is comprised of a graphene material. Cathode 116 may be comprised of carbon nanotubes operable to emit electrons in response to a potential difference between anode 110 and cathode 116. In one embodiment, cathode 116 comprises one or more needle-shapes pointed radially toward notched focal spot portion 120 on anode 110. In another embodiment, cathode 116 comprises knife-edged shapes oriented radially toward notched focal spot portion 120 on anode 110.

Proximal end portion 124 of anode 110 and proximal end portion 106 of tube body 102 may further comprise a high voltage electrical connection 126 to electrically connect anode 110 to a high voltage electrical source (not shown), for example, a high voltage electrical source in a portable X-ray device. Both anode 110 and cathode 116 may be operatively connected to a high voltage electrical source (not shown) that may create a potential difference between anode 110 and cathode 116.

A potential difference that may be created between anode 110 and cathode 116, for example, a potential difference that may be created by a short duration, high voltage electrical pulse, may cause a potential difference such that electrons (not shown) emitted from cathode 116 may be accelerated toward, and may collide with a notched focal spot portion 120 on anode 110, such that collision of electrons with anode 110 may produce X-rays. In one embodiment, a potential difference between anode 110 and cathode 116 is created by a high voltage electrical pulse that may be about 10 ns to about 100 ns in duration. In one embodiment, a potential difference between anode 110 and cathode 116 is created by a high voltage electrical pulse that may be about 100 kV to about 400 kV peak. In one embodiment, electrons emitted from cathode 116 and accelerated toward anode 110 by a potential difference created by a high voltage electrical pulse collide with notched focal spot portion 120 of anode 110 to produce X-rays. Notched focal spot portion 120 of anode 110 may be operable to direct an output of X-rays from anode 110, for example, in a direction substantially orthogonal to longitudinal axis of anode 110.

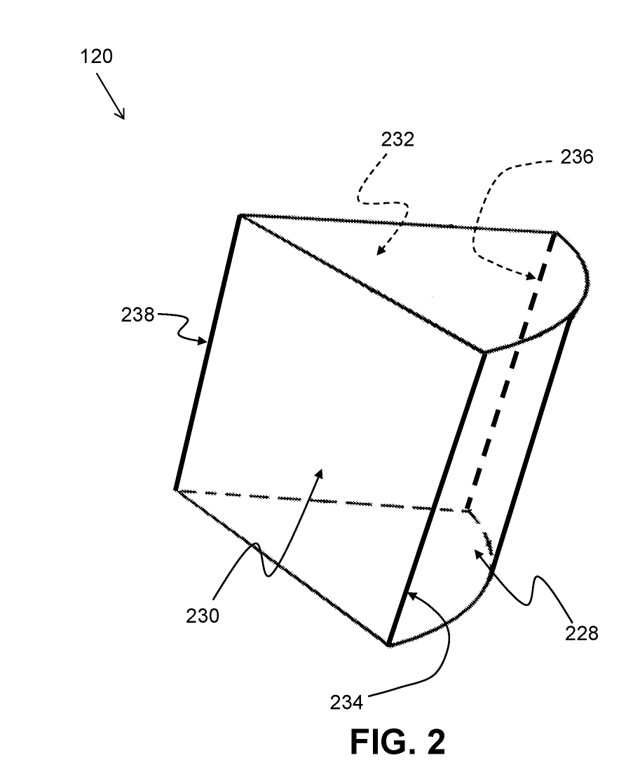

With reference to FIG. 2, a perspective view of an example geometry of notched focal spot portion 120 on anode 110 is illustrated. In one embodiment, notched focal spot portion 120 is shaped like an axe head/wedge with a pie-shaped cross-section. Notched focal spot portion 120 may comprise: an arcuate poll 228, a first face 230, and a second face 232, similar to an axe head/wedge. Arcuate poll 228 may comprise a first face edge 234 where arcuate poll 228 connects to first face 230, and a second face edge 236 where arcuate poll 228 connects to second face 232. First face 230 and second face 232 may connect at a common blade edge 238.

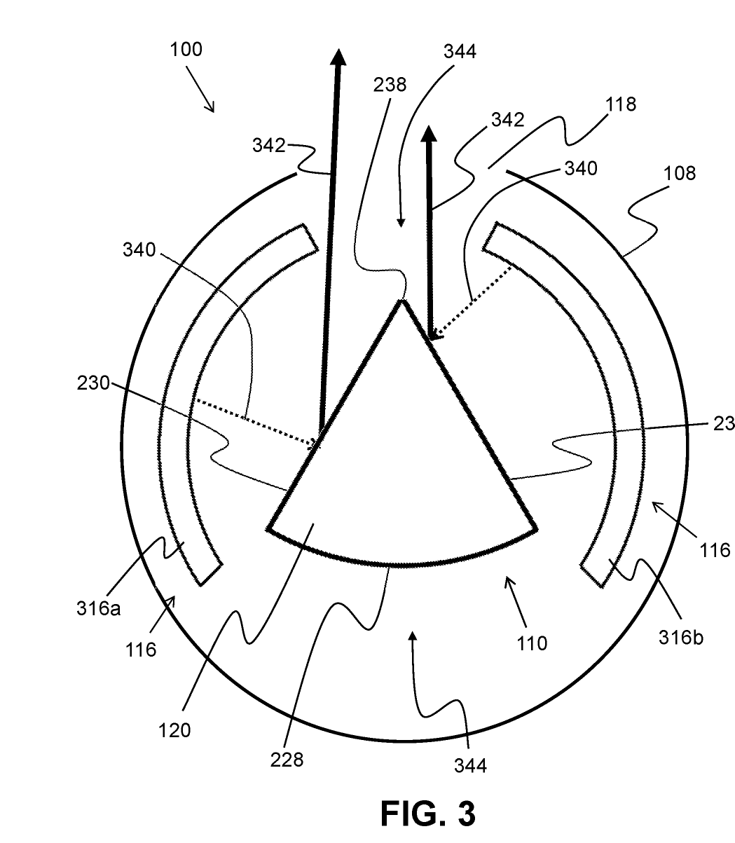

With reference to FIG. 3, a cross-sectional view of notched focal spot portion 120 on anode 110 for example X-ray tube 100 is illustrated. As discussed above, a cross section of notched portion 120 may be shaped like a pie slice, with arcuate pole 228, first face 230, second face 232, and blade edge 238 as boundary edges defining a pie slice shape.

In response to a large potential difference between anode 110 and cathode 116, electrons 340 may be emitted from cathode 116, and accelerated radially toward notched focal spot portion 120 of anode 110, such that electrons 340 colliding with notched focal spot portion 120 on anode 110 may produce X-rays 342. In one embodiment electrons 340 collide with at least one of first face 230 and second face 232 to produce X-rays 342. Geometry of notched focal spot portion 120 may influence an output direction of X-rays 342 generated when electrons 340 collide with at least one of: first face 230, and second face 232, such that X-rays 342 may be generated and output in a direction toward blade edge 238.

Cathode 116 may be shaped as diametrically opposed incomplete semicircles, such that, for example, an inner arcuate edge of a first incomplete semicircle-shaped cathode 316a may be oriented toward first face 230, and an inner arcuate edge of a second incomplete semicircle-shaped cathode 316b may be oriented toward an second face 232. Cathode 116 may comprise a discontinuity 344 between first incomplete semicircle-shaped cathode 316a and second incomplete semi-circle shaped cathode 316b. Discontinuity 344 may be a section removed from a complete annular shaped cathode, wherein electrons 340 may not be emitted from discontinuity 344 toward anode 110. In one embodiment, discontinuity 344 overlies and corresponds radially to both blade edge 238 and collimator window 118 on cathode cap 114. In another embodiment, discontinuity 344 overlies and corresponds radially to arcuate pole 228 so as to limit electrons 340 that are emitted toward arcuate pole 228. Electrons 340 colliding with arcuate poll 228 of notched focal spot portion 120 may generate X-rays 342 that may be transmitted through a portion of cathode cap 114, or into cathode cap 114 and attenuated. Removing a portion of a ring-shaped cathode 116 that may be in radial relation to arcuate poll 228 to create discontinuity 344 may limit an acceleration of electrons 340 from cathode 116 toward arcuate poll 228, and may further limit a generation and emission of X-rays 342 on arcuate poll 228, as X-rays generated on arcuate poll 228 may not be directionally output through collimator window 118.

X-rays 342 generated from electrons 340 colliding with at least one of: first face 230, and second face 232, on notched focal spot portion 120 of anode 110, may be output in a direction of blade edge 238 through collimator window 118 on cathode cap 114 and external to X-ray tube 100, for example, in a direction substantially orthogonal to a longitudinal axis of anode 110.

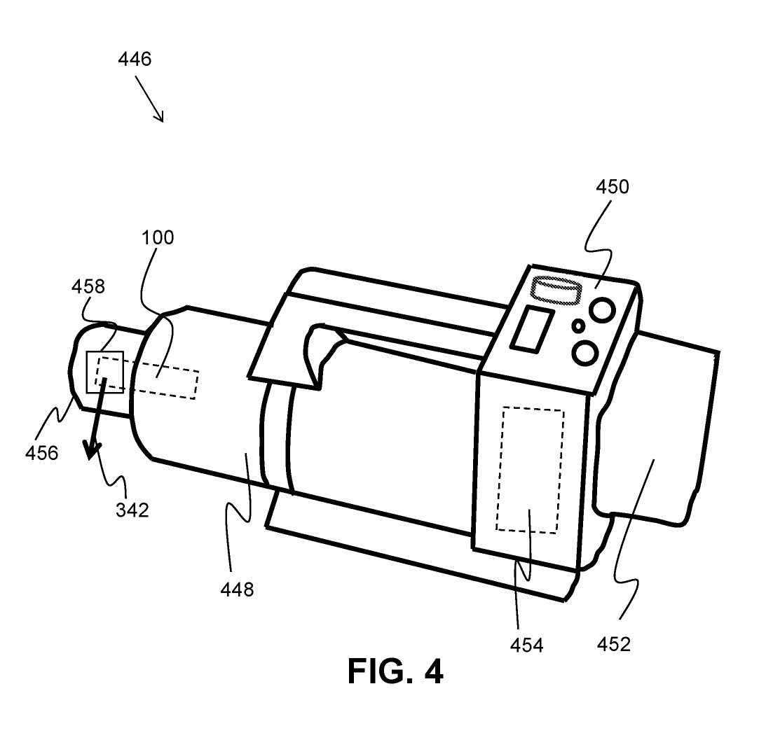

With reference to FIG. 4, an example portable X-ray device 446 is illustrated. Example portable X-ray device 446 may be used with X-ray tube 100 to generate and output X-rays 342, for example, in a direction substantially orthogonal to a longitudinal axis of both X-ray tube 100 and elongated canister portion 448 of portable X-ray device 446. X-ray device 446 may comprise necessary hardware such as a control module 450 for controlling an energy of X-ray 342 output from portable X-ray device 446, wherein control module 450 may be operatively connected to at least one: power source 452, and a high-voltage pulse generator 454. High voltage pulse generator 454 may be operatively connected by an electrical connection to anode (not shown) within X-ray tube 100. In one embodiment, power source 452 is a rechargeable power source 452 that selectively attaches to portable X-ray device 446 and is easily removed to recharge power source 452. In one embodiment, a distal end 456 of elongated canister portion 448 includes a canister collimator window 458 that outputs X-rays produced by X-ray tube 100, for example, in a direction substantially orthogonal to a longitudinal axis of both X-ray tube 100 and canister 448. Portions of elongated canister portion 448 and portions within an inner volume of elongated canister portion 448 may comprise lead shielding (not shown) to attenuate X-rays. For example, X-rays output from X-ray tube 100 that may not be output through canister collimator window 458, may strike lead shielding (not shown) to attenuate X-rays. Shielding (not shown) may be comprised of another heavy metal such as tantalum, and tungsten, and their alloys.

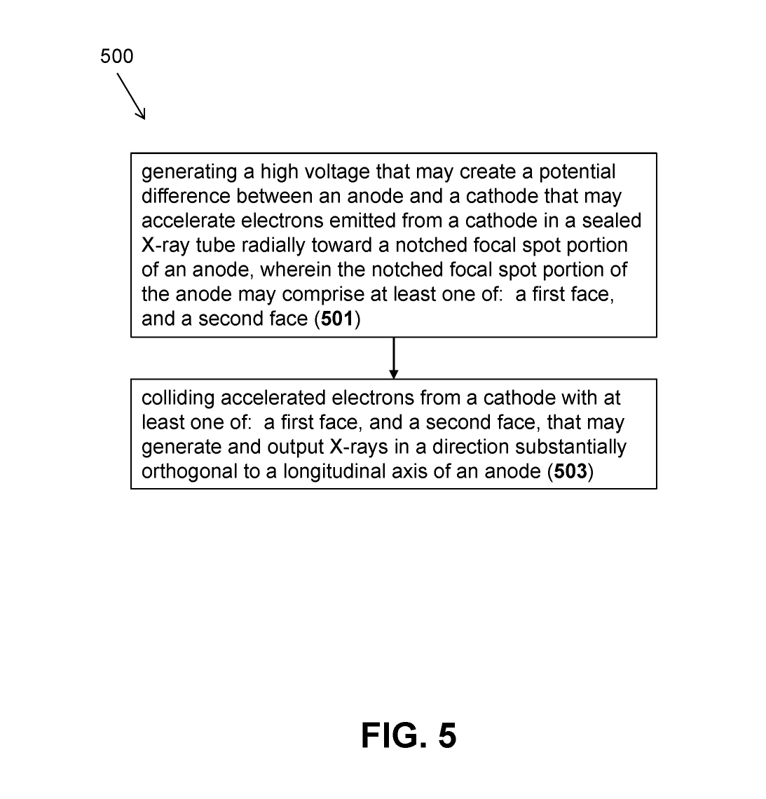

With reference to FIG. 5, a flowchart illustrating an example method 500 for producing and outputting X-rays for radiography is provided. Method 500 for producing and outputting X-rays for radiography may comprise: generating a high voltage pulse that may create a potential difference between an anode and cathode to accelerate electrons emitted from a cathode in a sealed X-ray tube radially toward a notched focal spot portion of an anode, wherein the notched focal spot portion of the anode may comprise at least one of: a first face, and a second face (501); colliding accelerated electrons from a cathode with at least one of: a first face, and a second face, that may generate and output X-rays in a direction substantially orthogonal to a longitudinal axis of an anode (503).

Unless specifically stated to the contrary, the numerical parameters set forth in the specification, including the attached claims, are approximations that may vary depending on the desired properties sought to be obtained according to the exemplary embodiments. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Furthermore, while the systems, methods, and apparatuses have been illustrated by describing example embodiments, and while the example embodiments have been described and illustrated in considerable detail, it is not the intention of the applicants to restrict, or in any way limit, the scope of the appended claims to such detail. It is, of course, not possible to describe every conceivable combination of components or methodologies for purposes of describing the systems, methods, and apparatuses. With the benefit of this application, additional advantages and modifications will readily appear to those skilled in the art. Therefore, the invention, in its broader aspects, is not limited to the specific details and illustrative example and exemplary embodiments shown and described. Accordingly, departures may be made from such details without departing from the spirit or scope of the general inventive concept. Thus, this application is intended to embrace alterations, modifications, and variations that fall within the scope of the appended claims. The preceding description is not meant to limit the scope of the invention. Rather, the scope of the invention is to be determined by the appended claims and their equivalents.

As used in the specification and the claims, the singular forms “a,” “an,” and “the” include the plural. To the extent that the term “includes” or “including” is employed in the detailed description or the claims, it is intended to be inclusive in a manner similar to the term “comprising,” as that term is interpreted when employed as a transitional word in a claim. Furthermore, to the extent that the term “or” is employed in the claims (e.g., A or B) it is intended to mean “A or B or both.” When the applicants intend to indicate “only A or B, but not both,” then the term “only A or B but not both” will be employed. Similarly, when the applicants intend to indicate “one and only one” of A, B, or C, the applicants will employ the phrase “one and only one.” Thus, use of the term “or” herein is the inclusive, and not the exclusive use. See Bryan A. Garner, A Dictionary of Modern Legal Usage 624 (2d. Ed. 1995). Also, to the extent that the terms “in” or “into” are used in the specification or the claims, it is intended to additionally mean “on” or “onto.” To the extent that the term “selectively” is used in the specification or the claims, it is intended to refer to a condition of a component wherein a user of the apparatus may activate or deactivate the feature or function of the component as is necessary or desired in use of the apparatus. To the extent that the term “operatively connected” is used in the specification or the claims, it is intended to mean that the identified components are connected in a way to perform a designated function. Finally, where the term “about” is used in conjunction with a number, it is intended to include ±10% of the number. In other words, “about 10” may mean from 9 to 11.

What is claimed is:

1. A sealed X-ray tube for use in small X-ray source devices, comprising:
a tube body comprising a distal end and a proximal end and at least one side extending in an axial direction to interconnect the distal end and the proximal end;
an anode positioned on a central axis of the tube body and within the tube body, the anode comprising a notched focal spot portion, wherein the notched focal spot portion is operable to direct an emission of X-rays out of the tube body in a direction substantially orthogonal to a longitudinal axis of the anode; and
a cathode cap, the cathode cap operable to seal the distal end of the tube body, wherein the cathode cap further comprises a cathode, the cathode operable to direct a flow of electrons toward the anode.

2. The sealed X-ray tube of claim 1, wherein the notched focal spot portion of the anode comprises an axe head/wedge shape comprising:
a poll comprising a first face edge and a second face edge;
a first face comprising a poll edge and a blade edge; and
a second face comprising a poll edge and a blade edge,
wherein the poll edge of the first face is operatively connected to the first face edge of the poll, and wherein the poll edge of the second face is operatively connected to the second face edge of the poll, and wherein the blade edge of the first face and the blade edge of the second face operatively connect to form a blade edge of the notched portion.

3. The sealed X-ray tube of claim 2, wherein electrons emitted by the cathode and colliding with at least one of: the first face, and the second face, of the notched focal spot portion of the anode, are emitted as X-rays in a direction of the blade edge on the notched focal spot portion.

4. The sealed X-ray tube of claim 1, wherein the notched focal spot portion is located at a distal portion of the anode.

5. The sealed X-ray tube of claim 1, wherein the anode comprises a tungsten material.

6. The sealed X-ray tube of claim 1, wherein the cathode comprises a woven graphite fabric material.

7. The sealed X-ray tube of claim 1, wherein the cathode comprises diametrically opposed incomplete semicircle shapes, the diametrically opposed incomplete semicircle shapes separated by a discontinuity portion, wherein the discontinuity portion overlies and is radially relative to at least one of: a blade edge, and an arcuate poll, on the notched focal spot portion of the anode.

8. The sealed X-ray tube of claim 7, wherein the discontinuity portion of the cathode is located radially relative to a collimator window on the cathode cap.

9. The sealed X-ray tube of claim 1, wherein the cathode cap further comprises a collimator window, the collimator window operable to allow transmission of X-rays from the notched focal spot portion of the anode through collimator window and external to the X-ray tube.

10. The sealed X-ray tube of claim 1, wherein a portion the cathode cap comprises at least one of: a stainless steel material, and a weldable metal, the portion of the cathode cap configured to be welded to a portion on the distal end of the tube body comprising at least one of: a stainless steel material, and a weldable metal.

11. The sealed X-ray tube of claim 1, wherein the proximal end portion of the tube body comprises a high voltage electrical connection to operatively connect the anode within the tube body, and the cathode to a high voltage electrical source.

12. The sealed X-ray tube of claim 1, wherein the at least one side of the tube body comprises at least one of: a glass material, and a ceramic material.

13. A portable X-ray source to generate X-rays for radiography, the portable X-ray source comprising:
an elongated canister portion comprising a sealed X-ray tube comprising a notched anode operable to emit X-rays in a direction substantially orthogonal to an axis of the notched anode, the sealed X-ray tube positioned within an internal volume of the elongated canister portion;
and at least one of:
a control module operatively connected to at least one of: a power source, and a high-voltage pulse generator; and
a canister collimator window through which X-rays emitted from the sealed X-ray tube may be directed toward a target source to be radiographed.

14. The portable X-ray source of claim 13, wherein the sealed X-ray tube further comprises:
a tube body comprising a distal end and a proximal end and at least one side extending in an axial direction to interconnect the distal end and the proximal end;
the notched anode positioned on a central axis of the tube body and within the tube body, the notched anode comprising a notched focal spot portion, wherein the notched focal spot portion is operable to direct an emission of X-rays out of the tube body; and
and a cathode cap, the cathode cap operable to seal the distal end of the tube body, wherein the cathode cap further comprises a cathode, the cathode operable to direct a flow of electrons toward the notched focal spot portion on the notched anode.

15. The portable X-ray source of claim 14, wherein the notched focal spot portion of the notched anode comprises an axe head/wedge shape further comprising: a poll comprising a first face edge and a second face edge; a first face comprising a poll edge and a blade edge; and a second face comprising a poll edge and a blade edge, wherein the poll edge of the first face is operatively connected to the first face edge of the poll, and wherein the poll edge of the second face is operatively connected to the second face edge of the poll, and wherein the blade edge of the first face and the blade edge of the second face operatively connect to form a blade edge of the notched focal spot portion.

16. The portable X-ray source of claim 15, wherein electrons emitted by the cathode and accelerated toward the notched focal spot portion of the notched anode, and colliding with at least one of: the first face, and the second face, of the notched focal spot portion, are emitted as X-rays in a direction of the blade edge on the notched focal spot portion.

17. The portable X-ray source of claim 14, wherein the notched focal spot portion is located at a distal portion of the notched anode.

18. The portable X-ray source of claim 14, wherein the notched anode comprises a tungsten material.

19. The portable X-ray source of claim 14, wherein the cathode comprises a woven graphite fabric material.

20. The portable X-ray source of claim 14, wherein the cathode comprises diametrically opposed incomplete semicircle shapes, the diametrically opposed incomplete semicircle shapes separated by a discontinuity portion, wherein the discontinuity portion overlies and is radially relative to at least one of: a blade edge, and an arcuate poll, on the notched focal spot portion on the notched anode.

21. The portable X-ray source of claim 20, wherein the discontinuity portion of the cathode is located radially relative to a collimator window on the cathode cap, and a canister collimator window.

22. The portable X-ray source of claim 14, wherein the cathode cap further comprises a collimator window, the collimator window operable to allow transmission of X-rays emitted from the notched focal spot portion of the notched anode through the collimator window and external to the X-ray tube.

23. The portable X-ray source of claim 14, wherein a portion the cathode cap comprises at least one of: a stainless steel material, and a weldable metal, the portion of the cathode cap configured to be welded to a portion on the distal end of the tube body comprising at least one of: a stainless steel material, and a weldable metal.

24. The portable X-ray source of claim 14, wherein the proximal end portion of the tube body comprises a high voltage electrical connection to operatively connect the notched anode within the tube body, and the cathode, to the high-voltage pulse generator.

25. The portable X-ray source of claim 14, wherein the at least one side of the tube body comprises at least one of: a glass material, and a ceramic material.

26. The portable X-ray source of claim 13, wherein at least one of: portions of the elongated canister portion, and portions within an internal volume of the elongated canister portion, further comprise a lead shielding configured to attenuate X-rays produced by the sealed X-ray tube.

27. A method for producing and outputting X-rays for radiography, the method comprising:
generating a high voltage pulse to create a potential difference between an anode and a cathode to accelerate electrons emitted from a cathode in a sealed X-ray tube radially toward a notched focal spot portion of an anode, wherein the notched focal spot portion of the anode comprises at least one of: a first face, and a second face; and
colliding accelerated electrons from the cathode with the at least one of: the first face, and the second face, to generate and output X-rays in a direction substantially orthogonal to a longitudinal axis of the anode.
